(19) United States
(12) Patent Application Publication
(10) Pub. No.: US 2002/0004762 A1
(43) Pub. Date: Jan. 10, 2002

(54) Ticket sales system and ticket sales method using an IC card, and computer program product

(75) Inventor: Atsushi Izumoto, Tokyo (JP)

Correspondence Address: SUGHRUE, MION, ZINN,, MACPEAK & SEAS, PLLC, 2100 Pennsylvania Avenue, N.W., Washington, DC, 20037-3202, US

(73) Assignee: NEC CORPORATION

(21) Appl. No.: 09/899,174

(22) Filed: Jul. 6, 2001

(30) Foreign Application Priority Data
Jul. 7, 2000 (JP) 2000-207058

(51) Int. Cl. G06F 17/60

(52) U.S. Cl. 705/26; 705/5; 705/41

(57) ABSTRACT

From a user terminal purchase order is sent to a sales center over a network when a user who wants to purchase a ticket, in the sales center, on receipt of the purchase order sending ticket information to the user terminal if the sales center receives permission information from a charge transfer terminal, wherein the user terminal on receipt of ticket information from the sales center, generates an IC card, on which the ticket information is stored, using an IC card writer connected to the user terminal, and wherein when the user uses a ticket of the IC card, a gate terminal reads the ticket information stored on the ticket card via an IC card reader to send the ticket information that is read to the sales center, the sales center comparing ticket information received with ticket information stored in the sales center, the gate terminal controls user's admission based on a comparison result sent from the sales center.

### FIELD OF THE INVENTION

The present invention relates to a ticket sales method and a ticket sales system, and more particularly to a ticket sales business method and a ticket sales business system using a networked computer system.

### BACKGROUND OF THE INVENTION

In a typical conventional sales method of selling tickets such as a ticket for an event, a travel ticket and etc., a ticket is sold in such a way that a customer goes to a ticket sales window at which a ticket that he or she desires to purchase is on sale, gets a ticket (usually, made of paper) printed out by a printer dedicated for a ticket printing and pays for the ticket at the ticket sales window.

Even with a conventional sales method of on-line shopping using a network such as the Internet for a ticket sales, a ticket must be printed out by a dedicated printer.

In such a publication as Japanese Patent Publication Kokai JP-A No. 2000-90168 an IC card ticket system is disclosed. With this IC card ticket system, a ticket buyer using a communication terminal accesses a ticket center connected via a network with the terminal. The ticket center calculates a ticket ID based on a buyer's unique ID delivered to the buyer and ticket type to transport the calculated ticket ID to the communication terminal. An IC card writer connected to the communication terminal writes the ticket ID into an IC card to create a ticket. The system records information on the ticket (buyer, user, usage status, etc.) into a database to manage distribution status of tickets. The IC card ticket system requires a device to be installed at a place where the ticket is to be used. This device, which has an IC card reader installed, compares a buyer ID (or password, buyer ID) recorded on an IC card ticket with that recorded on the user card and verifies that the ticket is a valid one for a corresponding performance or event to be held.

### SUMMARY OF THE INVENTION

However, the conventional ticket sales method has problems described below.

A first problem is that a customer must go to a ticket sales window in order to get a ticket.

A second problem is that there exists some limitation in time for a custom to get a ticket. That is, a customer can purchase a ticket only within a time interval during which a ticket sales window is open.

Even with a ticket on-line shopping using a network, a printed ticket (made of paper, etc.) is distributed for delivery to the buyer.

In view of the foregoing, it is a major object of the present invention to provide a ticket sales system, a ticket sales method, and a computer program product that eliminate need for a customer to go to a ticket sales window, eliminates need for a ticket to be delivered to a customer who purchases it, and makes it easy to purchase and use a ticket.

It is another object of the present invention to provide a ticket sales system, a ticket sales method, and a computer program product that check if a ticket used by a customer is used for an intended event or an intended public transport to prevent the ticket from being used illegally.

Another object of the present invention is to provide a ticket sales system, a ticket sales method, and a computer program product that combine a plurality of tickets into one card to make it easy for the user to manage a ticket during a trip. Other objects, features, and advantages of the present invention will become readily apparent to those skilled in the art from the following description of embodiments below.

The present invention achieves the above objects as described below. In accordance with one aspect of the invention, a user sends an order via a network from a user terminal to a sales center, which upon receipt of the order sends ticket information to the user terminal, to which is connected an IC card reader/writer that writes the ticket information on an IC card, from which ticket information is read by an IC card reader connected to a gate terminal when a ticket is used.

In accordance with another aspect of the invention, a ticket sales method comprises the steps of; sending a ticket purchase order from a user terminal to a sales center connected via a network when a user is to purchase a ticket;

upon receipt of the ticket purchase order by said sales center, checking if there is a problem with a payment of a ticket charge to send ticket information and buyer identification information to the user terminal if there is no problem;

recording the ticket information and the buyer identification information on the user terminal on a card comprising a recording medium, based on the information sent from said sales center to said user terminal by recording means for recording information on a recording medium;

making card reading means of a ticket gate terminal read the card when the user carryng the card on which the ticket information and the buyer identification information are recorded goes to a ticket usage place;

comparing ticket information corresponding to the ticket to be used by the user and the buyer identification information, both of which are included in the information on the card read by said ticket gate terminal, with the ticket information and the buyer identification information stored in said sales center; and

controlling an admission of the user based on the comparison result.

ordering a ticket from a user terminal to a sales center connected to said user terminal via a network, said ticket being purchased by a user;

upon receipt of the ticket order by said sales center, sending ticket information and buyer identification information to said user terminal;

recording the ticket information and the buyer identification information, sent to said user terminal, onto an IC card using an IC card reader connected to said user terminal; and

having the IC card read by an IC card reader of a ticket gate terminal to grant or reject an admission of the user when the user having said IC card, goes to a ticket window to use the ticket.

In accordance with another aspect of the invention, a ticket sales method comprising the steps of:

(a) sending purchase order information and credit card information from a user terminal by a user (hereinafter called a buyer) who orders a ticket to a sales center via a network, said purchase order information being product information on a ticket to be purchased, said credit card information being used for transferring a charge;

(b) said sales center sending credit instruction information to a charge-transfer terminal connected to said sales center, based on the credit card information, on receiving from said user terminal the purchase order information and the credit card information used for transferring the charge;

(c) said charge-transfer terminal transferring the charge based on the credit instruction information to send charge transferability information to said sales center, said charge transferability information indicating whether the charge may be transferred;

(d) said sales center generating buyer identification information for identifying a buyer, order contents, and an order date/time, based on the purchase order information, if the charge transferability information from said charge-transfer terminal indicates that the charge may be transferred, wherein said sales center sends the buyer identification information generated as well as the ticket information to said user terminal, and stores the ticket information and the buyer identification information into a database at said sales center;

(e) said sales center generating ticket unavailability information to send the information to said user terminal if the charge transferability information sent from said charge-transfer terminal indicates that the charge cannot be transferred or in case the ticket is out of stock and cannot be sold;

(f) said user terminal receiving the ticket information and the buyer identification information from said sales center to write the ticket information and the buyer identification information on an IC card with an IC card writer connected to the user terminal; and

(g) said user terminal displaying information, indicating that the user-ordered ticket could not be purchased, on a display on said user terminal if the ticket unavailability information was received from said sales center.

The ticket sales method further comprises the steps, for using the ticket purchased by the buyer, of:

(h) making an IC card reader read the IC card on which the ticket information and the buyer identification information are written, said IC card reader being connected to a ticket gate terminal installed in a predetermined place at a ticket gate or an admission entrance;

(i) said ticket gate terminal reading the ticket information and the buyer identification information from the IC card via the IC card reader to display the ticket information on a display unit of said ticket gate terminal, said ticket gate terminal sending selected ticket information, as well as buyer identification information corresponding to the selected ticket information, to said sales center over the network;

(j) upon receipt of the ticket information and the buyer identification information from said ticket gate terminal by said sales center, comparing the ticket information and the buyer identification information received with ticket information and buyer identification information stored in the database at said sales center to send a comparison result to said ticket gate terminal; and

(k) said ticket gate terminal in receipt of the comparison result sent from said sales center controlling admission such that the user is granted an admission if the comparison result is true and the user is rejected if the comparison result is false.

In accordance with another aspect of the invention is provided a ticket sales system comprising a user terminal, a sales center connected to said user terminal, and a ticket gate terminal connected to said sales center. The user terminal comprises means for sending ticket purchase information on a ticket a user is going to purchase to said sales center, the sales center comprises means for receiving the ticket purchase information; means for electronically issuing a ticket; and means for sending ticket information on the issued ticket to said user terminal, and said user terminal further comprises means for recording the ticket information on a card based on the ticket information sent from said sales center. When the user uses the ticket, the ticket information on the card is read by card reading means of said ticket gate terminal, said ticket information that has been read compared by said sales center with ticket information stored in said sales center sending comparison result to said ticket gate terminal to control an admission of the user based on the comparison result.

In accordance with another aspect of the invention is provided a ticket sales system comprising a user terminal, a sales center connected to said user terminal, and a charge-transfer terminal connected to said sales center,

wherein said user terminal comprises means for sending purchase order information and credit card information to said sales center, said purchase order information being entered by a user (hereinafter called a buyer) who orders a ticket and being product information on the ticket the user wants to purchase, said credit card information being entered by the user for use of transferring a charge,

wherein said sales center comprises:

means for receiving from said user terminal the purchase order information and the credit card information used for transferring the charge;

means for generating credit instruction information, based on the credit card information to send said credit instruction information to a charge-transfer terminal;

means for generating buyer identification information, based on the purchase order information to send the generated information, as well as ticket information on the purchased ticket, to said user terminal if charge transferability information sent from said charge-transfer terminal indicates that the charge may be transferred, said buyer identification information identifying a buyer, order contents, and an order date/time;

means for storing the ticket information and the buyer identification information in a database; and

means for generating unavailability information to send the information to said user terminal if the charge transferability information sent from said charge-transfer terminal indicates that the charge cannot be transferred;

wherein said charge-transfer terminal comprises:

means for transferring a charge based on a credit instruction information;

means for sending charge transferability information to said sales center, said transferability information indicating whether the charge may be transferred, and

wherein said user terminal further comprises means for receiving the buyer identification information and the ticket information from said sales center,

means for writing the ticket information on an IC card with an IC card writer connected to said user terminal; and

means for displaying information, indicating that the ordered ticket could not be purchased, on said user terminal if the unavailability information is received from said sales center.

In accordance with another aspect of the invention is provided a terminal device connected to a ticket sales center unit over a network, comprising:

means for displaying ticket product information on a display unit of said terminal device, said ticket product information being sent from said sales center unit over the network;

means for sending purchase order information and credit card information to said sales center unit over the network, said purchase order information being entered from an input unit by a user (hereinafter called a buyer) who orders a ticket and being product information on the ticket to be purchased, said credit card information being entered from the input unit by the user and being used for transferring a charge;

means for receiving the ticket information and the buyer identification information from said sales center unit that received the purchase order information and the credit card information used for transferring the charge;

means for sending the ticket information and the buyer identification information to an IC card writer connected to said user terminal to write the information on an IC card; and

means for displaying information when unavailability information is received from said sales center unit, said information indicating that the ordered ticket could not be purchased.

In accordance with another aspect of the invention is provided a ticket sales center unit connected to a user terminal and a charge-transfer terminal over a network, comprising:

means for receiving, from said user terminal, purchase order information and credit card information used for transferring a charge;

means for generating credit instruction information based on the credit card information to send said charge-transfer terminal;

means for generating buyer identification information based on the purchase order information to send the buyer identification information, as well as information on a purchased ticket, to said user terminal unit if charge transferability information from said charge-transfer terminal indicates that the charge may be transferred, said buyer identification information indicating a buyer, order contents, and an order date/time; and

means for generating unavailability information and sending the unavailability information to said user terminal if the charge transferability information sent from said charge-transfer terminal indicates that the charge cannot be transferred.

In accordance with another aspect of the invention is provided a charge-transfer terminal connected to the sales center comprising

means for transferring a charge; and

means for sending charge transferability information to said sales center, based on the credit instruction information sent from said sales center, said charge transferability information indicating whether the charge may be transferred.

In accordance with another aspect of the invention is provided a ticket gate terminal connected to a sales center unit, installed at a predetermined place such as a ticket gate or an admission entrance, and having an IC card reader installed, comprising:

means for reading, via the IC card reader, ticket information and buyer identification information from an IC card on which the ticket information and the buyer identification information are written and for sending the ticket information and the buyer identification information to said sales center unit, wherein said sales center unit, upon receipt of the ticket information and the buyer identification information from said ticket gate terminal, compares the received ticket information and the buyer identification information with ticket information and buyer identification information stored in a database at said sales center unit when said sales center unit generated the ticket information, and sends the comparison result to said ticket gate terminal;

means for receiving the comparison result from said sales center unit; and

means for controlling an admission of a user such that the user is admitted if the comparison result is true and is rejected if the comparison result is false.

In accordance with another aspect of the invention is provided a computer program product causing a computer on a user terminal to execute processes of following steps (a1)-(a5), said user terminal being connected to a ticket sales center unit over a network:

(a1) displaying ticket product information on a display unit of said user terminal, said ticket product information being sent from said sales center unit over the network;

(a2) sending purchase order information and credit card information to said sales center unit over the network, said purchase order information being entered from an input unit by a user (hereinafter called a buyer) who orders a ticket and being product information on the ticket to be purchased, said credit card information being entered from the input unit by the user and being used for transferring a charge;

(a3) receiving the buyer identification information and the ticket information from said sales center unit that received the purchase order information and the credit card information used for transferring the charge;

(a4) sending the buyer identification information and the ticket information to an IC card writer connected to said user terminal, to write the information on an IC card; and

(a5) displaying information when unavailability information is received from said sales center unit, said information indicating that the ordered ticket could not be purchased.

In accordance with another aspect of the invention is provided a computer program product causing a server computer on a sales center unit to execute processes of following steps (b1)-(b4), said sales center unit being connected to a user terminal and a charge-transfer terminal over a network:

(b1) receiving, from said user terminal, purchase order information and credit card information used for transferring a charge;

(b2) generating credit instruction information based on the credit card information to send said credit instruction information to said charge-transfer terminal;

(b3) generating buyer identification information based on the purchase order information to send said buyer identification information, as well as information on a purchased ticket, to said user terminal unit if charge transferability information from said charge-transfer terminal indicates that the charge may be transferred, said buyer identification information indicating a buyer, order contents, and an order date/time; and

(b4) generating unavailability information to send the unavailability information to said user terminal if the charge transferability information sent from said charge-transfer terminal indicates that the charge cannot be transferred.

In accordance with another aspect of the invention is provided a computer program product causing a computer on a ticket gate terminal to execute processes of following steps (c1)-(c4), said ticket gate terminal being connected to a sales center unit, installed at a predetermined place such as a ticket gate or an admission entrance, and connected to an IC card reader:

(c1) reading, via the IC card reader, ticket information and buyer identification information from an IC card on which the ticket information and the buyer identification information are written, display the ticket information on a display unit of said ticket gate terminal;

(c2) sending the ticket information selected by a user from the ticket information displayed on the display unit, as well as the buyer identification information corresponding to the ticket information, to said sales center unit, wherein said sales center unit, upon receipt of the ticket information and the buyer identification information from said ticket gate terminal, compares the received ticket information and the buyer identification information with ticket information and buyer identification information stored in a database at said sales center unit when the ticket information was generated, and sends the comparison result to said ticket gate terminal;

(c3) receiving a comparison result from said sales center unit; and

(c4) controlling an admission of a user such that the user is admitted if the comparison result is true and is rejected if the comparison result is false.

Still other objects and advantages of the present invention will become readily apparent to those skilled in this art from the following detailed description, wherein only the preferred embodiment of the invention is shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing a configuration of a first embodiment of the present invention.

FIG. 2 is a flowchart (part 1) showing processing procedure for the first embodiment of the present invention.

FIG. 3 is a flowchart (part 2) showing a processing procedure for the first embodiment of the present invention.

FIG. 4 is a flowchart (part 3) showing a processing procedure for the first embodiment of the present invention.

FIG. 5 is a diagram schematically showing an example of a ticket product information screen in the first embodiment of the present invention.

FIG. 6 is a diagram schematically showing an example of a credit card information entry screen of a credit card from which a charge is to be transferred.

FIG. 7 is a diagram schematically showing an example of a screen of ticket information, which is stored on an IC card, displayed on a gate terminal in the first embodiment of the present invention.

FIG. 8 is a flowchart (part 1) showing the processing procedure for the second embodiment of the present invention.

FIG. 9 is a flowchart (part 2) showing the processing procedure for the second embodiment of the present invention.

FIG. 10 is a flowchart (part 3) showing the processing procedure for the second embodiment of the present invention.

FIG. 11 is a diagram showing an example of the configuration of a user terminal in the first and second embodiments of the present invention.

FIG. 12 is a diagram showing an example of the configuration of a sales center terminal in the first and second embodiments of the present invention.

FIG. 13 is a diagram showing an example of the configuration of a charge transfer terminal in the first and second embodiments of the present invention.

FIG. 14 is a diagram showing an example of the configuration of the gate terminal in the first embodiment of the present invention.

### PREFERRED EMBODIMENTS OF THE INVENTION

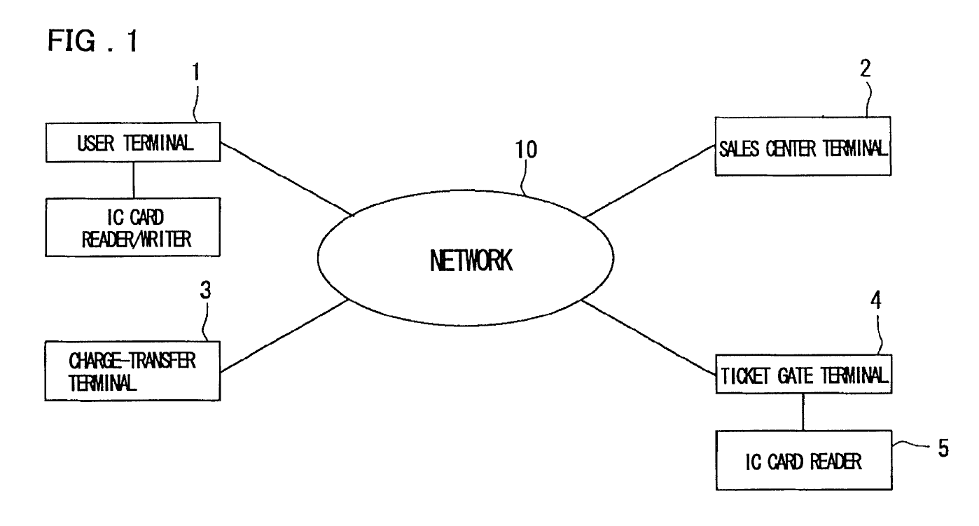

Some embodiments of the present invention will now be described more in detail. There is shown in FIG. 1 a diagram of a system configuration of an embodiment of the present invention. Referring to FIG. 1, a user who is going to order a ticket (hereinafter called a buyer) uses a user terminal (1) to send a purchase order information which is product information on a ticket to be purchased, as well as credit card information used for transferring (pulling down) a charge, to a sales center terminal (2) via a network (10).

Upon receiving the purchase order information and the credit card information for transferring the charge sent from the user terminal (1), the sales center terminal (2) sends credit instruction information to a charge-transfer terminal (3) based on the credit card information.

Next, the charge-transfer terminal (3) executes a process of transferring a charge based on the credit instruction information and sends charge transferability information to the sales center terminal (2) indicating whether the charge may be transferred (pulled down) or not.

Next, if the charge transferability information indicates that the charge may be transferred, the sales center terminal (2) generates buyer identification information, which identifies the buyer, order content, and order date/time, based on the purchase order information and sends the generated information, as well as information on the purchased ticket, to the user terminal (1).

On the other hand, if the charge transferability information indicates that the charge cannot be transferred, the sales center terminal (2) generates purchase failure (unavailability) information and sends it to the user terminal (1).

The user terminal (1) receives the buyer identification information and the ticket information from the sales center terminal (2) and writes the ticket information on an IC (integrated circuit) card inserted into an IC card reader/writer (not shown) connected to the user terminal (1).

If the purchase failure information is received, information indicating that the ordered ticket could not be purchased is displayed on the user terminal (1).

Next, when the buyer uses a purchased ticket, he or she has an IC card on which the ticket information is written in a manner as mentioned above read by a IC card reader (5) accommodated on a ticket gate terminal (4) installed at a ticket gate or an admission entrance.

The ticket gate terminal (4) reads ticket information and buyer identification information from the IC card via the IC card reader (5) and sends the ticket information and the buyer identification information (buyer ID) to the sales center terminal (2) via the network (10).

Receiving the ticket information and the buyer identification information sent from the ticket gate terminal (4), the sales center terminal (2) compares the received information with ticket information and buyer identification information stored in a database (not shown) of the sales center terminal (2), and sends comparison result to the ticket gate terminal (4).

The ticket gate terminal (4) receives the comparison result from the sales center terminal (2), admits the user if the comparison result is true (match), and rejects the user if the comparison result is false.

In one embodiment of the present invention, a user terminal connected to a ticket sales center unit over a network comprises,

(a1) means for displaying ticket product information on a display unit of the user terminal, the ticket product information being sent from the sales center unit over the network;

(a2) means for sending purchase order information and credit card information to the sales center unit over the network, the purchase order information being entered from an input unit by a user (hereinafter called a buyer) who orders a ticket and being product information on the ticket to be purchased, the credit card information being entered from the input unit by the user and being used for transferring a charge;

(a3) means for receiving buyer identification information and ticket information from the sales center that received the purchase order information and the credit card information used for transferring the charge, for sending the ticket information from the IC card writer connected to the user terminal to the IC card, and for writing the information on the IC card; and

(a4) means for displaying information when purchase failure information is received from the sales center unit, the information indicating that the ordered ticket could not be purchased. The processing and functions of the means (a1) to (a4) are preferably implemented by executing a computer program product on a computer of the user terminal. In this case, the user terminal according to the present invention may be implemented by reading the program from a storage (computer-readable) medium (floppy diskette, CD-ROM, DVD (digital versatile disk), magnetic tape, or semiconductor memory) via a reading means of the computer and executing the program or by downloading the program from a server to the user terminal via a communication medium for installation and executing the program.

A sales center terminal (unit) connected to a user terminal and a charge-transfer (pulling down) terminal over a network, comprises:

(b1) means for receiving, from the user terminal, purchase order information and credit card information used for transferring a charge and, based on the credit card information, sending credit instruction information to the charge-transfer terminal;

(b2) means for generating buyer identification information based on the purchase order information and for sending the buyer identification information, as well as information on a purchased ticket, to the user terminal unit if charge transferability information from the charge-transfer terminal indicates that the charge may be transferred (pulled down), the buyer identification information indicating a buyer, order contents, and an order date/time; and

(b3) means for generating purchase failure (unavailability) information and sending the unavailability information to the user terminal if the charge transferability information sent from the charge-transfer terminal indicates that the charge cannot be transferred.

The sales center terminal further comprises (b4) means for receiving the ticket information and the buyer identification information, sent from a ticket gate terminal installed at a predetermined place such as a gate or an admission entrance, the ticket gate terminal having an IC card reader installed and being connected to the sales center terminal, for comparing the received ticket information and the buyer identification information with ticket information and buyer identification informations both stored in a database at the sales center unit, and for sending the comparison result to the ticket gate terminal.

The processing and functions of the means (b1) to (b4) are preferably implemented by executing a computer program product on a server computer constituting the sales center terminal. In this case, the sales center terminal according to the present invention may be implemented by reading the program from a recording medium (floppy diskette, CD-ROM, DVD, magnetic tape, or semiconductor memory) via a predetermined reading means of the computer and executing the program or by downloading the program from other servers to the computer of the sales center terminal via a communication medium for installation and executing the program.

A charge-transfer terminal (pull down terminal) comprises means for transferring a charge and for sending charge transferability information to the sales center, based on a credit instruction information, the charge transferability information indicating whether the charge may be transferred. The processing and functions of the means are preferably implemented by executing a computer program product on the charge-transfer terminal computer. In this case, the charge-transfer terminal according to the present invention may be implemented by reading the program from a recording medium (floppy diskette, CD-ROM, DVD, magnetic tape, or semiconductor memory) via a predetermined reading means of the computer and executing the program or by downloading the program from servers to the computer of the charge-transfer terminal via a communication medium for installation and executing the program.

A ticket gate terminal connected to a sales center, installed at a predetermined place such as a ticket gate or an admission entrance, and having an IC card reader installed, comprises:

(C1) means for reading ticket information and buyer identification information from an IC card when the IC card on which the ticket information and the buyer identification information are written is inserted into the IC card reader and for sending the ticket information and the buyer identification information to the sales center,

wherein the sales center unit receives the ticket information and the buyer identification information sent from the ticket gate terminal, compares the received ticket information and the buyer identification information with ticket information and buyer identification information stored in a database provided at the sales center, and sends the comparison result to the ticket gate terminal, and

(C2) means for receiving the comparison result from the sales center unit and for controlling an admission of a user such that the user is admitted if the comparison result is true and is rejected if the comparison result is false. The processing and functions of the means are implemented by executing a program on the ticket gate terminal. In this case, the ticket gate terminal according to the present invention may be implemented by reading the program from a recording medium (floppy diskette, CD-ROM, DVD, magnetic tape, or semiconductor memory) via a predetermined reading means of the computer and executing the program or by downloading the program from servers to the computer of the ticket gate terminal via a communication medium for installation and executing the program.

Some embodiments of the present invention will be described more in detail with reference to the attached drawings. Referring to FIG. 1, the system comprises a user terminal 1, a sales center terminal 2, a charge-transfer terminal 3, a ticket gate terminal 4 that has an IC card reader 5, and a communication network 10 such as the Internet over which those terminals are interconnected.

The user terminal 1 is a data processing terminal, such as a personal computer, that has communication control means 11 for connecting to the communication network 10. The user terminal 1 may also be a portable terminal or a cellular phone.

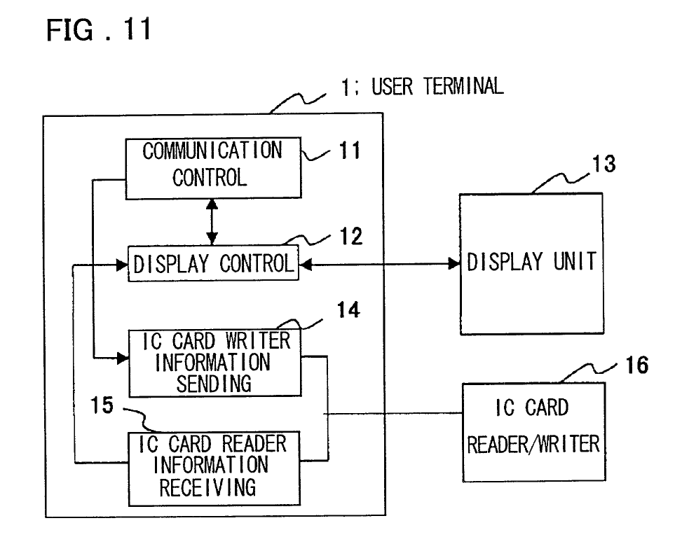

FIG. 11 illustrates a diagram of a configuration of a user terminal in one embodiments of the present invention. Referring to FIG. 11, the user terminal 1 has display control means 12. The display control means 12 accesses, via the communication control means 11, ticket product information (a web page opened on a WWW server in case the network 10 is the Internet), provided by the sales center terminal 2 on the network 10 and displays the ticket product information (screen information sent from the sales center terminal 2) on a display unit 13 of the user terminal 1. In addition, the user terminal 1 has IC card writer information sending means 14 and IC card reader information receiving means 15. The display control means 12 is implemented as a browser running on the user terminal 1 in case the network 10 is the Internet.

The ticket product information includes information on,

train ticket, reserved seat ticket, or

ticket for a event in a theater, and a stadium, an entrance ticket, or a seat reservation ticket, etc, and information of a name, a type, a seat number, and a price of a ticket.

The user may select a plurality of tickets from the ticket product information displayed on the user terminal 1 to order a plurality of tickets at a time.

Referring to FIG. 1 and FIG. 11, the buyer enters from the screen of the display unit 13 of the user terminal 1 a purchase order information comprising of information on a ticket that the buyer is going to purchase and a credit information comprising of information on a credit card company, account number, and ID card number of a credit card from which charge is to be transferred. The communication control means 11 of the user terminal 1 sends information entered to the sales center terminal 2 via the network 10.

The user terminal 1 is connectable to an IC card reader/writer 16 via a predetermined interface, such as an RS232 or USB (Universal Serial Bus) interface. The IC card writer information sending means 14 receives a ticket information and a buyer identification information from the sales center terminal 2 via the communication control means 11, and sends them to the IC card reader/writer 16 connected to the user terminal 1. The IC card reader/writer 16 writes the ticket information and the buyer identification information on an IC card. It is assumed that the user has already obtained an IC card by applying to a ticket sales company or a credit card company or etc. The IC card may have a user personal information recorded thereon when issued or may have an electronic signature recorded thereon as necessary.

The IC card reader information receiving means 15 of the user terminal 1 receives ticket information, which is read by the IC card reader, from the IC card reader/writer 16 to confirm the ticket information recorded on the IC card and displays the ticket information on the display unit.

The user terminal 1 may be a ticket user's own personal computer (connected to the IC card/reader) connectable to the network (Internet) or a terminal (with an IC card writer/reader) installed in a convenience store.

Of course, the user terminal 1 may also be installed in a ticket agency or a travel guide center to enable a clerk to operate in response to a user's request. The terminal installed in such a place may contributes to a wide spread use of IC card tickets even to such a user who is unfamiliar with terminal operation.

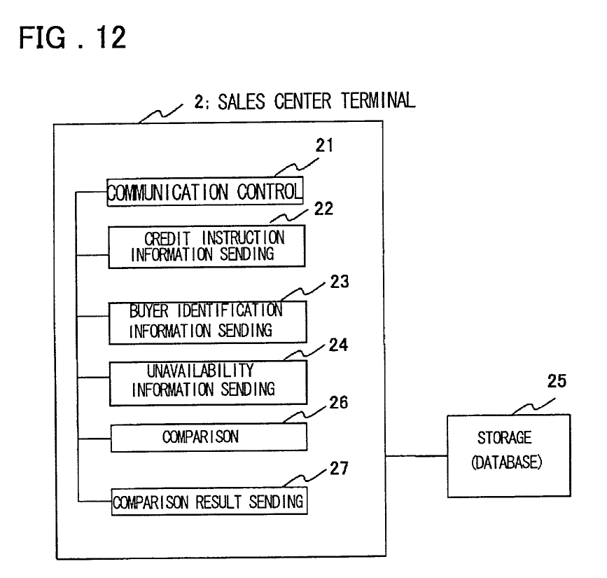

In FIG. 12 illustrates a diagram of a configuration of the sales center terminal 2 used in one embodiment of the present invention. Referring to FIG. 12, the sales center terminal 2, which is used by a product provider, is an information processing equipment such as a server machine or a host computer. The sales center terminal 2 comprises communication control means 21 used to connect the terminal to a network such as the Internet, credit card instruction information sending means 22, buyer identification information sending means 23, unavailability information sending means 24, storage means 25, comparison means 26, and comparison result sending means 27.

In the sales center terminal 2, the credit card instruction information sending means 22 receives purchase order information and credit card information entered by the buyer on the user terminal 1, automatically generates credit instruction information based on the credit card information, and sends the credit instruction information to the charge-transfer terminal 3.

The buyer identification information sending means 23 check charge-transferability information sent from the charge-transfer terminal 3 that received the credit instruction information. If it is checked that the charge may be transferred (pulled down), the sales center terminal 2 generates buyer identification information including the following based on the purchase order information,

Buyer's name

Order contents, and

Order date/time and sends generated buyer identification information to the user terminal 1.

On the other hand, if the charge may not be transferred, the purchase failure (unavailability) information sending means 24 generates unavailability information and sends the information to the user terminal 1 via the communication control means 21.

The storage means 25 stores therein ticket information and buyer identification information for later use in checking validity of a ticket sold when the ticket is used.

The comparison means 26 compares the buyer identification information and ticket information received from the ticket gate terminal 4 that reads information from the IC card with the buyer identification information and ticket information stored in the storage means 25 of the sales center terminal 2. The comparison result sending means 27 sends true/false information, generated as a result of comparison of the comparison means 26, to the ticket gate terminal 4.

The buyer identification information identifies the ticket buyer, order contents, and order date and time.

The buyer identification information is stored in the database of the sales center terminal 2 as customer management information and is also recorded on an IC card.

The sales center terminal 2 uses the buyer identification information to check to see if the customer who has ordered and bought the ticket is authorized to use an IC card ticket when he or she uses it. Therefore, this information prevents the contents of the IC card from being altered.

The credit information includes credit card information used to pull down charge from the buyer's account.

The charge-transfer terminal 3, installed in a finance institution office such as a credit card company that transfers the charge, comprises an information processing unit such as a server machine or a host computer.

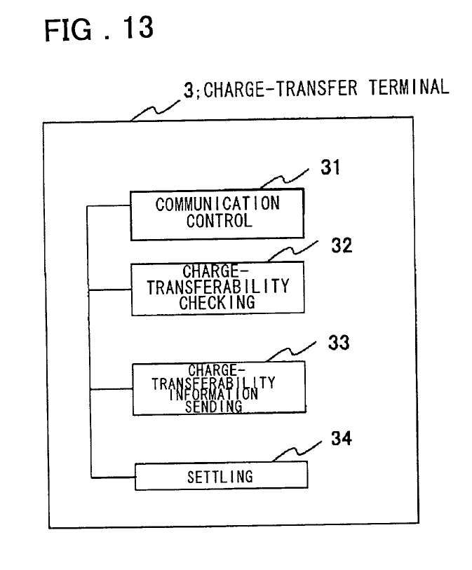

FIG. 13 illustrates a diagram of a configuration of the charge-transfer terminal 3 used in one embodiment of the present invention. Referring to FIG. 13, the charge-transfer terminal 3 comprises communication control means 31, charge-transferability checking means 32, charge-transferability information sending means 33, and settling means 34.

When the charge-transfer terminal 3 receives credit card instruction information from the sales center terminal 2 over the network, the charge-transferability checking means 32 searches customer information, stored in the charge-transfer terminal 3, for information on the buyer, matches the information of the buyer with the credit instruction information for authorization, and checks if the charge may be transferred.

The charge-transferability information sending means 33 sends the charge-transferability checking result to the sales center terminal 2 via the communication control means 31 for use as the charge-transferability information.

When the charge-transfer terminal 3 receives charge transfer directive information from the sales center terminal 2, the settling means 34 settles transaction.

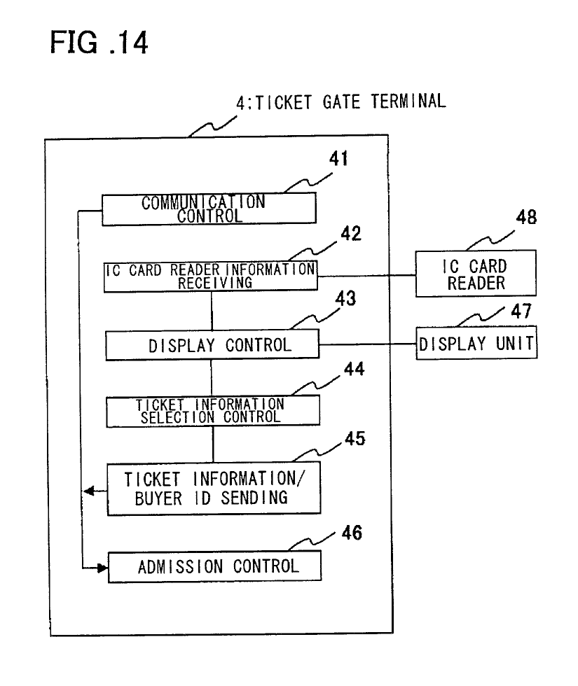

The ticket gate terminal 4 comprises a data processing unit such as a personal computer installed at the entrance or the gate where the ticket is used. FIG. 14 illustrates a diagram of a configuration of the ticket gate terminal 4 in one embodiment of the present invention

Referring to FIG. 14, the ticket gate terminal 4 comprises communication control means 41, IC card reader information receiving means 42 for receiving information read from an IC card inserted by the buyer into an IC card reader 48 (corresponding to the IC card reader 5 in FIG. 1), display control means 43 for displaying IC card ticket information on the screen of a display unit 47 based on card information received by the IC card reader information receiving means 42, ticket information selection control means 44 for allowing the buyer to select ticket information from the ticket information displayed on the screen and for receiving the selected ticket information, sending means 45 for sending the selected ticket information and buyer identification information to the sales center terminal 2, and admission control means 46 for checking the comparison result received from the sales center terminal 2. If the comparison result is true (match), the admission control means 46 opens the gate (not shown in the figure) to give admission to the user; if the result is false, the admission control means 46 closes the gate to reject the admission. Alternatively, the admission control means 46 may also be constructed to inform a ticket checking clerk to grant admission to the user if the comparison result is true (match), and to reject the admission if the comparison result is false.

In this case, a user selects desired ticket information from a ticket information (information on the ticket the user bought from the sales center) displayed on the screen of the ticket gate terminal 4. For example, when the user bought a plurality of tickets (information on the plurality of tickets is written on IC card), the user may select a ticket information corresponding to a place where a ticket is used. Or, when the user bought a plurality of tickets for a plurality of family members (for example, information on four tickets being written on an IC card) and the user uses two tickets of them, the user selects the two tickets.

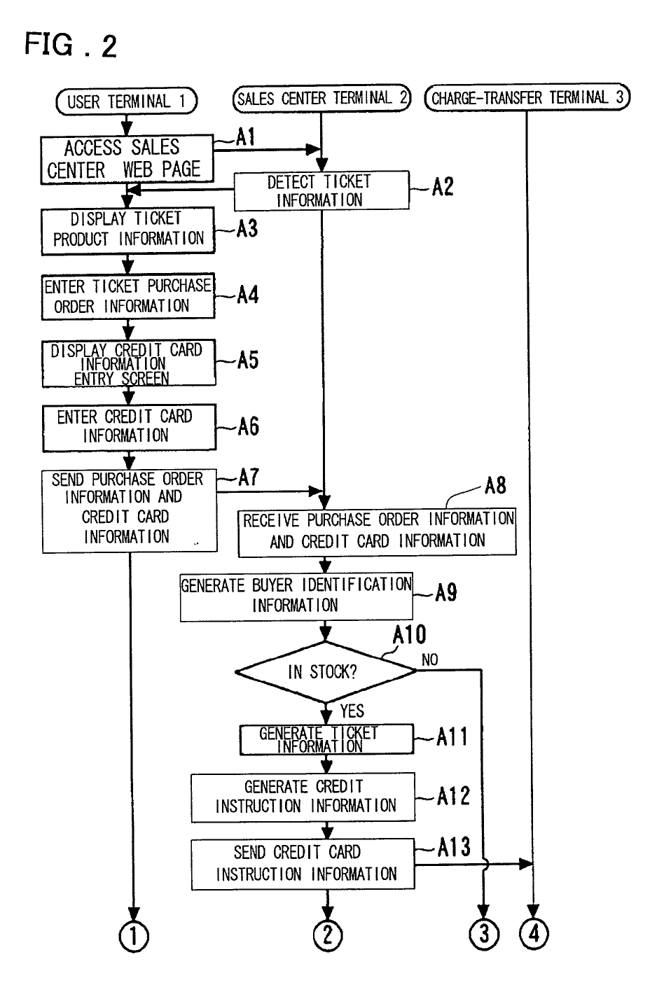

Next, referring to FIGS. 1-7, the operation of the embodiment of the present invention will be described more in detail. In the description below, the network 10 is assumed to be the Internet. FIGS. 2-4 illustrate flowcharts describing the processing procedure for the embodiment of the present invention. Note that the flowchart is divided into FIGS. 2-4 only for convenience's sakes in drafting figures in limited space.

Referring to FIG. 1 and the flowchart in FIGS. 2-4, the buyer accesses, via his or her own user terminal 1, a product sales home (web) page established on the Internet 10 by the sales center (step A1 in FIG. 2). In response, the sales center terminal 2 sends ticket product information to the user terminal 1 (step A2).

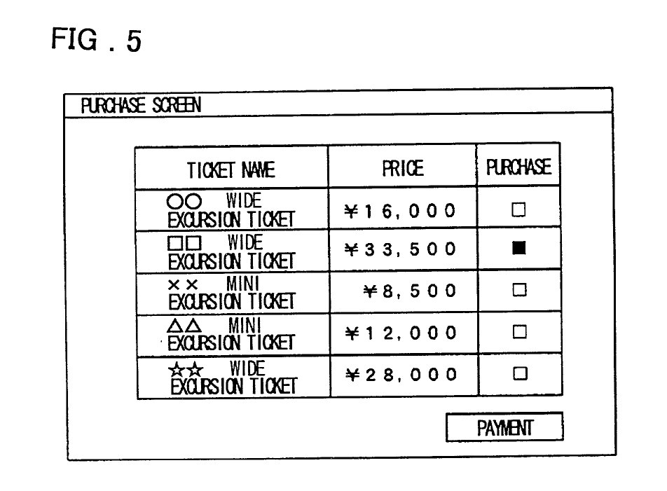

First, as shown schematically in FIG. 5, various types of ticket product information are displayed on the screen of the user terminal 1 (step A3). As shown in FIG. 5, on a browser screen of the user terminal 1, information on excursion tickets (wide- and mini excursion tickets) sent from the sales center terminal is displayed.

Looking at ticket product information displayed on the screen of the user terminal 1, the buyer determines a ticket that he or she desires to purchase and, from the screen, enters information indicating that the buyer purchase the ticket (step A4).

In the example shown in FIG. 5, when the buyer selects a purchase column of “□□ wide excursion ticket” with a pointing device such as a mouse or from a keyboard, the symbol is displayed (the symbol ▪ is attached to the selected item), and the excursion ticket is stored temporarily in the storage device of the user terminal 1 as the purchase order information.

For simplicity, an example of a screen from which a selection is made for each excursion ticket is shown in FIG. 5. The screen may also display a list of travel coupons provided by a travel agency. In such a case, the travel agency may provide a list of tickets required for a sequence of processes - - - routes, transportations (services), lodgings (hotels, inns), or meals - - - to allow the user to select desired services on the user terminal 1, with a multiple-ticket coupon written in one IC card. One of the advantages of the present invention is that, as compared with carrying a conventional coupon ticket made up of a plurality of paper tickets, a small-sized IC card is less bulky and more convenient for transportation. In addition, when a user's family is going to check in at a hotel and visit a recreation ground or a theme park the next day, the user may select multiple tickets (hotel ticket, passenger ticket, admission ticket, etc.) for each of the family from the user terminal 1 at one time and then have a plurality of ticket informations for each of personals of the family written on one IC card.

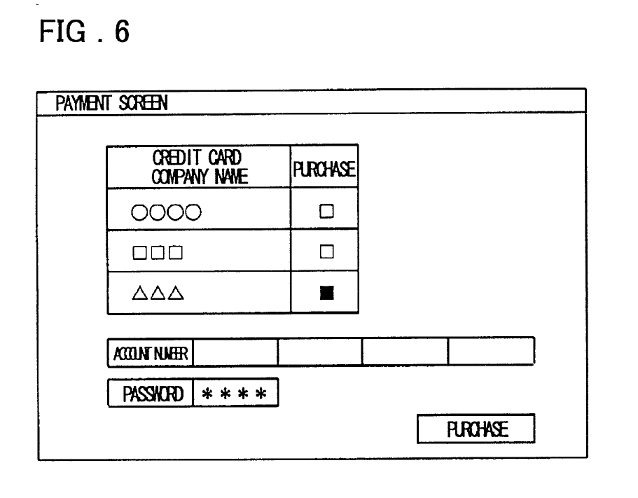

Upon finding an item to be modified, the buyer modifies the screen entry contents (selected contents). After confirming the settings on the screen, the buyer selects a “Payment” button on the screen of the user terminal 1. Then, the screen of the user terminal 1 is updated, and a credit card information entry screen (charge payment screen) of the credit card, from which the charge is to be transferred, is displayed as shown schematically in FIG. 6 (step A5).

The buyer enters his or her own credit card information (step A6). Entered credit card information is stored temporarily in the user terminal 1 as credit information.

The system checks to see if the purchase order information and the credit information stored in the user terminal 1 are valid. If they are valid, a buyer's purchase instruction is sent to the sales center terminal 2 via the Internet 10 when the user clicks a “Purchase” button, on the screen shown in FIG. 6, with the mouse (step A7).

In response to receiving the purchase order information and the credit information (step A8), the sales center terminal 2 generates buyer identification information that identifies the buyer and the purchase order contents using the received purchase order information (step A9).

In addition, the sales center terminal 2 checks ticket stock based on the purchase order information (step A10). If the ticket is in stock, the sales center terminal 2 generates ticket information (step A11) and, based on the credit information, generates credit instruction information (step A12) to send the credit instruction information to the charge-transfer terminal 3 over the Internet 10 (step A13).

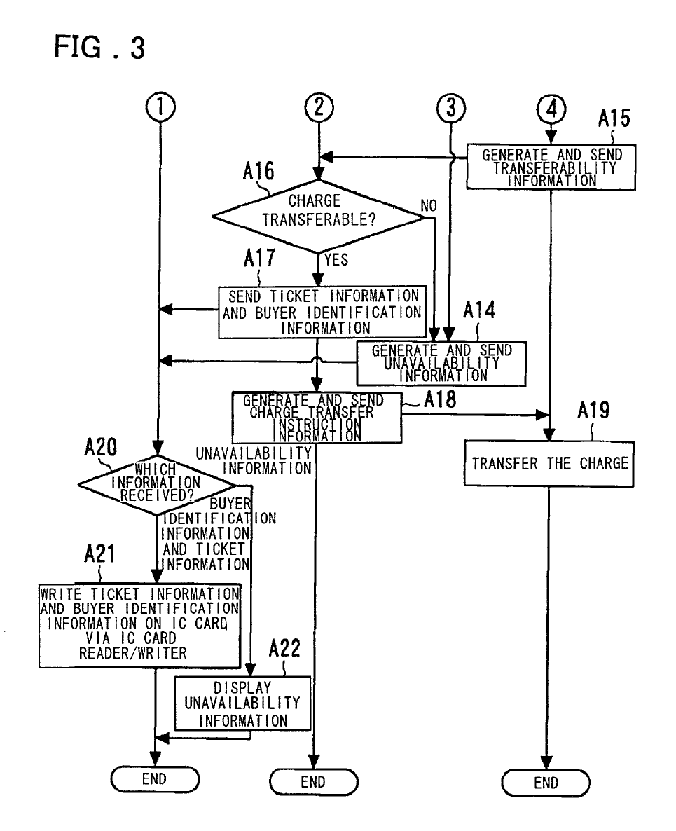

If, as a result of stock checking in step A10 in FIG. 2, it is found that the ticket is out of stock, the sales center terminal 2 generates purchase failure (unavailability) information and sends it to the user terminal 1 (step A14 in FIG. 3).

Referring to FIG. 1 and the flowchart in FIG. 3, the charge-transfer terminal 3 checks the received credit instruction information to see if the buyer is able to pay for a ticket and sends the result back to the sales center terminal 2 as the charge transferability information (step A15 in FIG. 3). The charge-transfer terminal 3 retrieves a customer database and checks customers credit information to see if the customer (buyer) is able to pay.

The sales center terminal 2 checks the charge transferability information received from the charge-transfer terminal 3 (step A16). If a charge for the ticket may be transferred (pulled down), the sales center terminal 2 sends the ticket information and the buyer identification information to the user terminal 1 (step A17).

The sales center terminal 2 also generates charge transfer instruction information and sends it to the charge-transfer terminal 3 (step A18).

On the other hand, if the charge-transfer terminal 3 judges that the charge cannot be transferred, the charge-transfer terminal 3 generates purchase failure (unavailability) information and sends the information to the user terminal 1 (step A14).

In response to the charge transfer instruction information, the charge-transfer terminal 3 transfers the charge (step A19).

The user terminal 1 checks the information received from the sales center terminal 2 (step A20). If the received information is ticket information and buyer identification information, the user terminal 1 writes the ticket information and the buyer identification information onto the IC card via the IC card reader/writer connected to the user terminal 1 (step A21).

If the information received from the sales center terminal 2 is purchase failure information, the user terminal 1 displays the information on the screen (step A22).

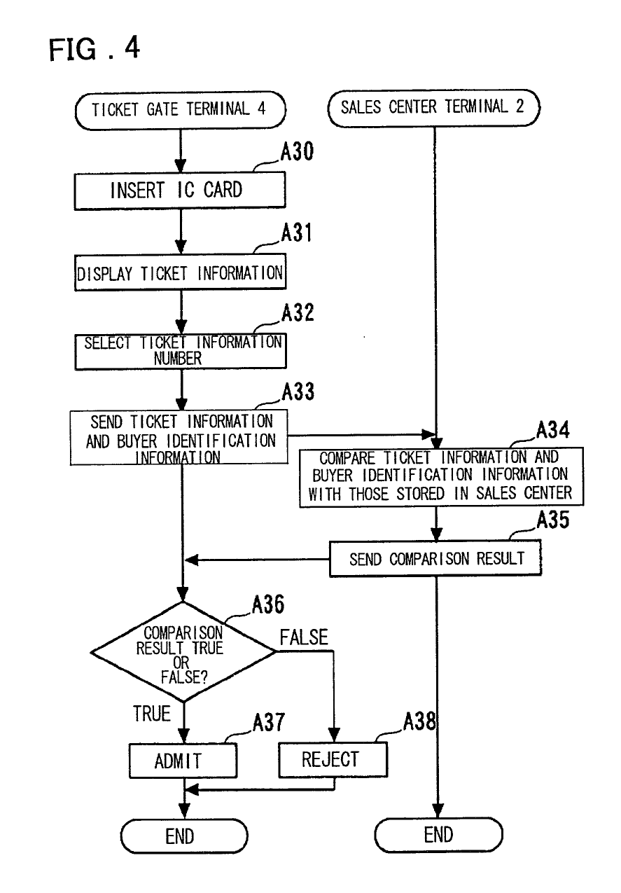

How a purchased ticket is used will be described with reference to the flowchart in FIG. 4. The buyer makes an IC card, on which ticket information and buyer identification information are written, read by a IC card reader 5 connected to a ticket gate terminal 4 installed at a theater or stadium entrance (step A30 in FIG. 4).

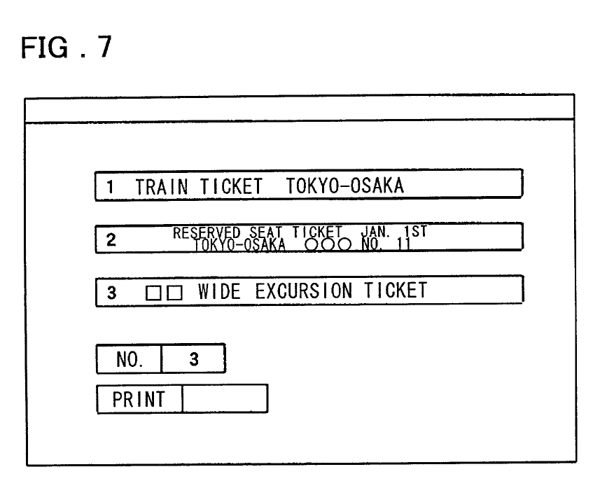

The ticket gate terminal 4 reads the ticket information from the IC card and, as shown in FIG. 7, displays the information on the display screen of the ticket gate terminal 4 (step A31). In the example shown in FIG. 7, a buyer has purchased a railway ticket from Tokyo to Osaka, a seat reservation ticket, and a wide excursion ticket, all of these ticket information being written on a IC card has the ticket information written thereon.

From the screen of the ticket gate terminal 4, the buyer selects the number of ticket information on the ticket he or she is going to use (step A32). In the example shown in FIG. 7, a wide excursion ticket is selected.

The ticket gate terminal 4 sends the selected ticket information and the buyer identification information to the sales center terminal 2 (step A33).

The sales center terminal 2 compares the ticket information and the buyer identification information received from the ticket gate terminal 4 with corresponding information recorded in the database at the sales center terminal 2 (step A34). Then, the sales center terminal 2 sends a comparison result true/false information (indicating whether the comparison result indicates a match) to the ticket gate terminal 4 (step A35).

The ticket gate terminal 4 checks the comparison result true/false information (step A36). If the result is true, the terminal gives admission to the buyer (step A37); if the result is false, the terminal rejects the buyer (step A38).

In the embodiment of the present invention, when ticket information and buyer identification information are sent from the sales center terminal 2 to the user terminal 1 in step A17 in FIG. 3, additional information may be sent to the user terminal 1 for writing it on an IC card. For example, if the user-ordered ticket is a railway excursion ticket, various types of information may also be stored for example, a sightseeing map information of the area and sightseeing guide information on scenic spots, places historic interest, a style of cooking peculiar to a certain locality, and hotels and inns. In addition, town information such as hospitals and public facilities may be stored as text information, screen information (image information), or voice guidance information. In this case, the user inserts the IC card into the IC card reader 5 of the ticket gate terminal 4 to display the sightseeing map or guidance information on the display of the ticket gate terminal 4.

Next, a second embodiment of the present invention will be described in detail with reference to the drawings. In the second embodiment of the present invention, a buyer purchases a ticket via a user terminal 1 and, before the buyer passes the ticket gate, prints the ticket information, stored on the IC card, on a special printer to issue the ticket.

The ticket gate terminal 4 displays information read from the IC card, receives buyer-selected ticket information, edits the ticket image based on the ticket information, and prints the edited image on a ticket printer connected to a ticket gate terminal 4. That is, in the second embodiment of the present invention, the ticket gate terminal 4 has a ticket printer (not shown in the figure) added to the configuration shown in FIG. 14.

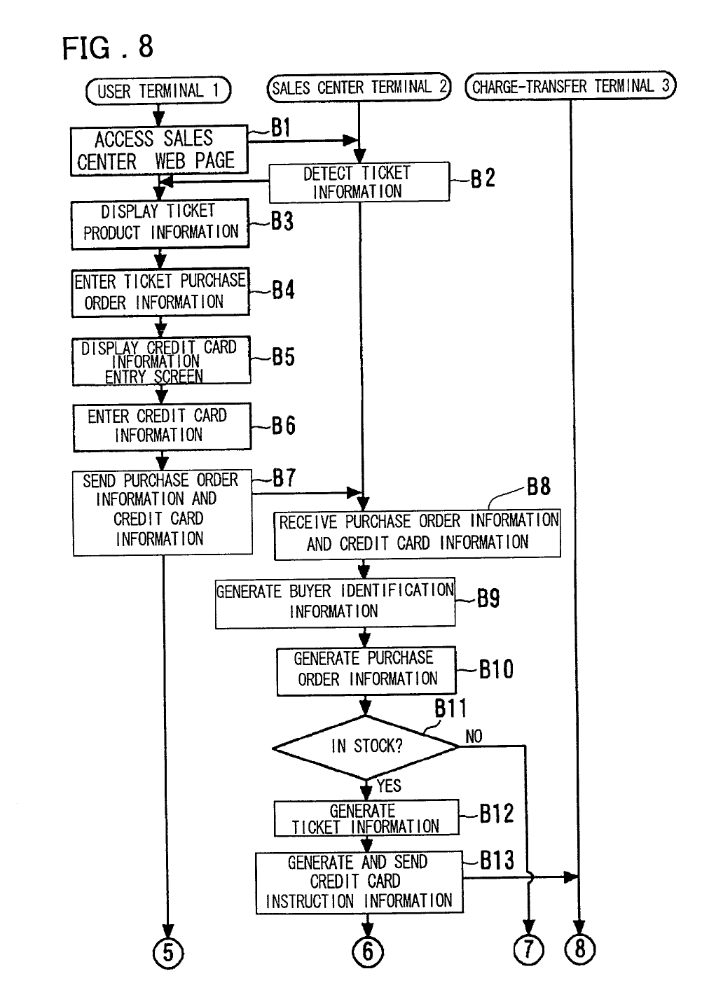

The operation of the second embodiment of the present invention will be described. FIGS. 8-10 are flowcharts showing the processing procedure of the second embodiment. Note that the flowchart is divided into FIGS. 8-10 only for convenience's sakes in drafting figures in limited space.

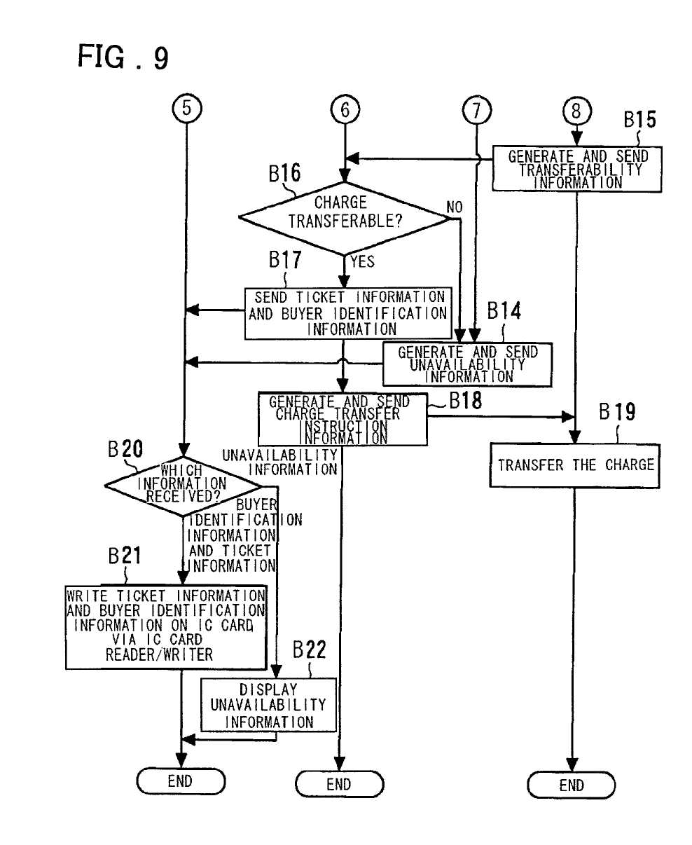

Referring to FIGS. 8-10, operation of steps in which the user terminal 1 receives ticket information and buyer identification information from a sales center terminal 2 over a network 10 and writes the received information on an IC card inserted into the IC card reader/writer (step B1 to step B22 in FIGS. 8-9) is the same as that of step A1 to step A22 of the first embodiment in FIGS. 2-3. Therefore, the description is omitted.

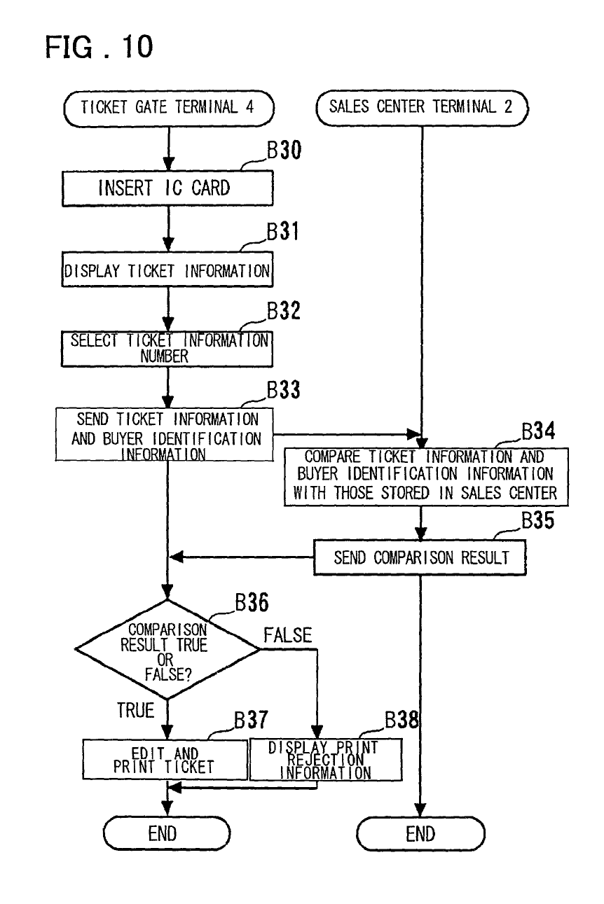

Before using the ticket, the buyer gets an IC card, on which ticket information and buyer identification information are written, read by an IC card reader 5 connected to the ticket gate terminal 4 at any one of locations where the ticket gate terminal 4 is installed in order to display the ticket information (see FIG. 7). This operation (step B30 to step B31 in FIG. 10) is also the same as that in the first embodiment (step A30 to step A31 in FIG. 4).

Next, when the buyer selects a ticket number at the ticket gate terminal 4 and requests a printout (see FIG. 7) (step B32 in FIG. 10), the ticket gate terminal 4 sends ticket information and buyer identification information to the sales center terminal 2 (step B33).

The sales center terminal 2 compares the ticket information and the buyer identification information received from the ticket gate terminal 4 with the corresponding information recorded in the database (step B34). Then the sales center terminal 2 sends the comparison result to the ticket gate terminal 4 (step B35).

The ticket gate terminal 4 checks the comparison result true/false information (step B36). If the result is true, the ticket gate terminal 4 prints a ticket on a ticket printer connected to the ticket gate terminal 4 (step B37).

If the comparison result is false, the ticket gate terminal 4 informs the buyer that a ticket cannot be printed (step B38).

The buyer may be admitted with the printed out ticket.

As described above, even in an environment in which a gate terminal is not available (when a buyer wants to buy a ticket in an area where the system according to the present invention is not applied), the system in the second embodiment of the present invention prints the ticket in advance to give the buyer the service equivalent to those provided by the conventional system. Some buyers may want to keep a ticket for remembrance. In such a case, printing the ticket may satisfy the buyer's request.

The drawings referenced in the description of the embodiment of the present invention are for illustrative purposes only, and it is to be understood that the present invention is not limited to the above embodiments but that various modifications and changes apparent to those skilled in the art may be made without departing from the spirit or scope of the claims.

The meritorious effects of the present invention are summarized as follows.

As described above, a first meritorious effect of the present invention is that a buyer on a terminal connectable to the Internet may purchase a ticket anywhere and anytime, without having to go to a ticket sales window, as long as a home or web page of the sales center is active.

A second meritorious effect of the present invention is that the sales center may increase the number of ticket sales windows without having to install additional ticket printing printers.

A third meritorious effect of the present invention is that a credit card company, rather than the sales center, processes the charge payment. This increases ticket sales efficiency.

A fourth meritorious effect of the present invention is that the ticket gate operations are automated.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A ticket sales method for use in a network system wherein at least a terminal and a sales center are coupled by a network communication comprising the steps of:
sending purchase order of a ticket to be purchased by a user from said terminal to said sales center;
upon receipt of the purchase order by said sales center sending ticket information to said terminal;
generating a card, said card having the ticket information recorded thereon by recording means for recording ticket information on a card, said recording means being connected to said user terminal; and
Getting said card having the ticket information recorded thereon read by reading means of a ticket gate terminal, said ticket gate terminal being installed at a ticket utilization place.

2. The ticket sales method as defined in claim 1, wherein said step of purchase ordering of the ticket comprises the steps of:
sending ticket product information from said sales center to said terminal via a network;
selecting from the ticket product information, displayed on said terminal, a ticket that the user is going to purchase; and
sending the purchase order of the ticket selected on said terminal to said sales center via said network.

3. The ticket sales method as defined in claim 1, wherein on one card is being recorded information on a plurality of tickets purchased by the user from said sales center.

4. The ticket sales method as defined in claim 3 further comprising the steps of:
displaying ticket information read from said card by said reading means on a display unit at said ticket gate terminal; and
allowing the user to select ticket information to be used from the displayed ticket information.

5. The ticket sales method as defined in claim 4, further comprising the step of:
sending the ticket information selected at said ticket gate terminal from said ticket gate terminal to said sales center;
upon receipt of the ticket information by said sales center comparing the ticket information with corresponding information stored in said sales center to check if the ticket information is valid; and
controlling an admission of the user in said ticket gate terminal based on a checking result at said sales center.

6. A ticket sales method comprising the steps of:
sending a ticket purchase order from a user terminal to a sales center connected via a network when a user is to purchase a ticket;
upon receipt of the ticket purchase order by said sales center checking if there is a problem with a payment of a ticket charge to send ticket information and buyer identification information to the user terminal if there is no problem;
recording the ticket information and the buyer identification information on the user terminal on a card comprising a recording medium, based on the information sent from said sales center to said user terminal by recording means for recording information on a recording medium;
making card reading means of a ticket gate terminal read the card when the user carrying the card on which the ticket information and the buyer identification information are recorded goes to a ticket usage place;
comparing ticket information corresponding to the ticket to be used by the user and the buyer identification information, both of which are included in the information on the card read by said ticket gate terminal, with the ticket information and the buyer identification information stored in said sales center; and
controlling an admission of the user based on the comparison result.

7. The ticket sales method as defined in claim 6, further comprising the step of making said card reading means read the ticket information recorded on the card and printing out the ticket information by a printer connected to said ticket gate terminal to create a ticket.

8. The ticket sales method as defined in claim 6, wherein the card on which the ticket information and the buyer identification information are recorded is generated by writing the ticket information and the buyer identification information on an IC card with an IC card writer connected to said user terminal.

9. The ticket sales method as defined in claim 6, wherein the buyer identification information includes a buyer's name, purchase order contents, and order date/time information,
wherein said sales center stores the ticket information and the buyer identification information, sent from said user terminal when the user purchases the ticket, into a database at said sales terminal, and
wherein, when the user uses the ticket, among the information read by said ticket gate terminal from the card, the ticket information and the buyer identification information, which are to be used by the user, are compared with the ticket information and the buyer identification information stored in the database at said sales center to prevent an illegal use of the cared.

10. The ticket sales method as defined in claim 6, wherein, when the user orders a ticket using said user terminal, the user informs said sales center of credit card information for use in charge payment.

11. A ticket sales method, comprising the steps of:
ordering a ticket from a user terminal to a sales center connected to said user terminal via a network, said ticket being purchased by a user;
upon receipt of the ticket order by said sales center, sending ticket information and buyer identification information to said user terminal;
recording the ticket information and the buyer identification information, sent to said user terminal, onto an IC card using an IC card reader connected to said user terminal; and
having the IC card read by an IC card reader of a ticket gate terminal to grant or reject an admission of the user when the user have said IC card and goes to a ticket window to use the ticket.

12. The ticket sales method as defined in claim 11, wherein said step of ordering the ticket comprises the steps of:
sending ticket product information from said sales center to said user terminal via said network when the user orders a ticket from said terminal;
selecting from the ticket product information, which is displayed on a display unit of said terminal, a ticket the user is going to purchase; and
sending a purchase order of the ticket selected on said terminal to said sales center over said network.

13. The ticket sales method as defined in claim 11, further comprising the step of:
reading the ticket information and the buyer identification information, which are recorded on the IC card, by an IC card reader connected to said user terminal and displaying the information on a display unit of said user terminal to allow the user to confirm the displayed information.

14. The ticket sales method as defined in claim 11, further comprising the steps of:
displaying the ticket information, read from the IC card by the IC card reader, on a display unit at said ticket gate terminal;
allowing the user to select from a screen of the display unit of said ticket gate terminal the ticket information to be used; and
sending the selected ticket information and buyer identification information corresponding to the selected ticket information to said sales center via said network for comparing with the information stored in a database at said sales center.

15. The ticket sales method as defined in claim 11, further comprising the step of:
printing out the ticket information being recorded on said IC card, with a printer connected to said ticket gate terminal to issue a ticket.

16. A ticket sales method comprising the steps of:
(a) sending purchase order information and credit card information from a user terminal by a user (hereinafter called a buyer) who orders a ticket to a sales center via a network, said purchase order information being product information on a ticket to be purchased, said credit card information being used for transferring a charge;
(b) said sales center sending credit instruction information to a charge-transfer terminal connected to said sales center, based on the credit card information, on receiving from said user terminal the purchase order information and the credit card information used for transferring the charge;
(c) said charge-transfer terminal transferring the charge based on the credit instruction information to send charge transferability information to said sales center, said charge transferability information indicating whether the charge may be transferred;
(d) said sales center generating buyer identification information for identifying a buyer, order contents, and an order date/time, based on the purchase order information, if the charge transferability information from said charge-transfer terminal indicates that the charge may be transferred, wherein said sales center sends the buyer identification information generated as well as the ticket information to said user terminal, and stores the ticket information and the buyer identification information into a database at said sales center;
(e) said sales center generating ticket unavailability information to send the information to said user terminal if the charge transferability information sent from said charge-transfer terminal indicates that the charge cannot be transferred or in case the ticket is out of stock and cannot be sold;
(f) said user terminal upon receipt of the ticket information and the buyer identification information from said sales center to write the ticket information and the buyer identification information on an IC card with an IC card writer connected to the user terminal; and
(g) said user terminal displaying information, indicating that the user-ordered ticket could not be purchased, on a display on said user terminal if the ticket unavailability information was received from said sales center.

17. The ticket sales method as defined in claim 16, further comprising the steps, for using the ticket purchased by the buyer, of:
(h) making an IC card reader read the IC card on which the ticket information and the buyer identification information are written, said IC card reader being connected to a ticket gate terminal installed in a predetermined place at a ticket gate or an admission entrance;
(i) said ticket gate terminal reading the ticket information and the buyer identification information from the IC card via the IC card reader to display the ticket information on a display unit of said ticket gate terminal, said ticket gate terminal sending selected ticket information, as well as buyer identification information corresponding to the selected ticket information, to said sales center over the network;
(j) upon receipt of the ticket information and the buyer identification information from said ticket gate terminal by said sales center, comparing the ticket information and the buyer identification information received with ticket information and buyer identification information stored in the database at said sales center to send a comparison result to said ticket gate terminal; and
(k) said ticket gate terminal in receipt of the comparison result sent from said sales center controlling admission such that the user is granted an admission if the comparison result is true and the user is rejected if the comparison result is false.

18. The ticket sales method as defined in claim 16, further comprising the steps, for using the ticket purchased by the buyer, of:
(l) making an IC card reader read the IC card on which the ticket information and the buyer identification information are written, said IC card reader being connected to a ticket gate terminal installed in a predetermined place at a ticket gate or an admission entrance;
(m) said ticket gate terminal, after reading the ticket information and the buyer identification information from the IC card via the IC card reader, displaying the ticket information on a display unit of said ticket gate terminal to send selected ticket information, as well as buyer identification information corresponding to the selected ticket information, to said sales center over the network;
(n) said sales center in receipt of the ticket information and the buyer identification information sent from said ticket gate terminal, comparing the received ticket information and the buyer identification information with ticket information and buyer identification information stored in the database at said sales center to send a comparison result to said ticket gate terminal; and
(o) said ticket gate terminal in receipt of the comparison result sent from said sales center, printing out ticket information on a printer connected to said ticket gate terminal to issue a ticket if the comparison result is true, said ticket gate terminal informing the user that the ticket cannot be issued if the comparison result is false.

19. The ticket sales method as defined in claim 16, wherein said sales center in receipt of the purchase sends not only the ticket information and the buyer identification information but also additional information associated with the ticket to said terminal, said terminal recording the additional information on the IC card.

20. A ticket sales system comprising a user terminal, a sales center connected to said user terminal over a network, and a ticket gate terminal connected to said sales center over a network,
wherein said user terminal comprises means for sending ticket purchase information on a ticket a user is going to purchase to said sales center,
wherein said sales center comprises:
means for receiving the ticket purchase information;
means for electronically issuing a ticket; and
means for sending ticket information on the issued ticket to said user terminal,
wherein said user terminal further comprises means for recording the ticket information on a card based on the ticket information sent from said sales center, and
wherein when the user uses the ticket, the ticket information on the card is read by card reading means of said ticket gate terminal, the ticket information that has been read compared by said sales center with ticket information stored in said sales center sending comparison result to said ticket gate terminal to control an admission of the user based on said comparison result.

21. A ticket sales system comprising a user terminal, a sales center connected to said user terminal over a network, and a charge-transfer terminal connected to said sales center over a network,
wherein said user terminal comprises means for sending purchase order information and credit card information to said sales center, said purchase order information being entered by a user (hereinafter called a buyer) who orders a ticket and being product information on the ticket the user wants to purchase, said credit card information being entered by the user for use of transferring a charge, wherein said sales center comprises:
means for receiving from said user terminal the purchase order information and the credit card information used for transferring the charge;
means for generating credit instruction information, based on the credit card information to send said credit instruction information to a charge-transfer terminal;
means for generating buyer identification information, based on the purchase order information to send the generated information, as well as ticket information on the purchased ticket, to said user terminal if charge transferability information sent from said charge-transfer terminal indicates that the charge may be transferred, said buyer identification information identifying a buyer, order contents, and an order date/time;
means for storing the ticket information and the buyer identification information in a database; and
means for generating unavailability information to send the information to said user terminal if the charge transferability information sent from said charge-transfer terminal indicates that the charge cannot be transferred,
wherein said charge-transfer terminal comprises:
means for transferring a charge based on a credit instruction information; and
means for sending charge transferability information to said sales center, said transferability information indicating whether the charge may be transferred, and
wherein said user terminal further comprises:
means for receiving the buyer identification information and the ticket information from said sales center;
means for writing the ticket information on an IC card with an IC card writer connected to said user terminal; and
means for displaying information, indicating that the ordered ticket could not be purchased, on said user terminal if the unavailability information is received from said sales center.

22. The ticket sales system as defined in claim 21 wherein, at said user terminal, the ticket product information sent from said sales center over the network is displayed on a display unit of said user terminal and wherein, from the displayed ticket product information, the user selects the ticket to be purchased.

23. The ticket sales system as defined in claim 21, further comprising a ticket gate terminal connected to said sales center, installed at a predetermined place such as a gate or an admission entrance, a ticket gate terminal having the IC card reader installed,
wherein said ticket gate terminal comprises means for sending the ticket information, which is to be used by the user and which, in conjunction with the buyer identification information, is written on the IC card read from the IC card reader, and the buyer identification information corresponding to the ticket information to said sales center over the network, when a user holding the IC card, on which the ticket information is written, makes the IC card reader of said ticket gate terminal read the information from the IC card,
wherein said sales center further comprises:
means for receiving the ticket information and the buyer identification information from said ticket gate terminal;
means for comparing the received ticket information and the buyer identification information with the ticket information and the buyer identification information stored in the database at the sales center; and
means for sending comparison result to said ticket gate terminal, and
wherein said ticket gate terminal further comprises:
means for receiving the comparison result form said sales center; and
means for controlling admission of the user holding the IC card such that the user is granted admission if the comparison result is true and is rejected if the comparison result is false.

24. The ticket sales system as defined in claim 22, wherein said ticket gate terminal reads the ticket information and the buyer identification information from the IC card via the IC card reader and sends the ticket information on the ticket to be used by the user, as well as the buyer identification information corresponding to the ticket information, to said sales center over the network,
wherein said sales center compares the ticket information and the buyer identification information sent from said ticket gate terminal with the ticket information and the buyer identification information stored in said sales center, and
wherein said ticket gate terminal further comprises:
means for receiving the comparison result from said sales center;
means for printing out a ticket if the comparison result is true when a print option is set; and
means for informing the user that the ticket cannot be issued if the comparison result is false.

25. The ticket sales system as defined in one of claims 20, 22, 23, and 24, wherein said ticket gate terminal displays the ticket information, which is read from said card reading means, on a display unit of said ticket gate terminal, and
wherein the user using a ticket selects a ticket to be used from the ticket information displayed on the display unit.

26. A terminal device connected to a ticket sales center unit over a network, comprising:
means for displaying ticket product information on a display unit of said terminal device, said ticket product information being sent from said sales center unit over the network;
means for sending purchase order information and credit card information to said sales center unit over the network, said purchase order information being entered from an input unit by a user (hereinafter called a buyer) who orders a ticket and being product information on the ticket to be purchased, said credit card information being entered from the input unit by the user and being used for transferring a charge;
means for receiving the ticket information and the buyer identification information from said sales center unit that received the purchase order information and the credit card information used for transferring the charge;
means for sending the ticket information and the buyer identification information to an IC card writer connected to said user terminal to write the information on an IC card; and
means for displaying information when unavailability information is received from said sales center unit, said information indicating that the ordered ticket could not be purchased.

27. A ticket sales center unit connected to a user terminal and a charge-transfer terminal over a network, comprising:
means for receiving, from said user terminal, purchase order information and credit card information used for transferring a charge;
means for generating credit instruction information based on the credit card information to send said charge-transfer terminal;
means for generating buyer identification information based on the purchase order information to send the buyer identification information, as well as information on a purchased ticket, to said user terminal unit if charge transferability information from said charge-transfer terminal indicates that the charge may be transferred, said buyer identification information indicating a buyer, order contents, and an order date/time; and
means for generating unavailability information to send the unavailability information to said user terminal if the charge transferability information sent from said charge-transfer terminal indicates that the charge cannot be transferred.

28. The sales center unit as defined in claim 27, further comprising:
means for receiving the ticket information and the buyer identification information sent from a ticket gate terminal installed at a predetermined place such as a gate or an admission entrance and having an IC card reader installed;
means for comparing the received ticket information and the buyer identification information with ticket information and buyer identification information stored in a database at said sales center unit; and
means for sending comparison result to said ticket gate terminal.

29. The charge-transfer terminal connected to the sales center as defined in claim 27 or 28 comprising:
means for transferring a charge for the ticket purchased; and
means for sending charge transferability information to said sales center, based on the credit instruction information sent from said sales center unit as defined in claim 27 or 28, said charge transferability information indicating whether the charge may be transferred.

30. A ticket gate terminal connected to a sales center unit, installed at a predetermined place such as a ticket gate or an admission entrance, and having an IC card reader installed, comprising:
means for reading, via the IC card reader, ticket information and buyer identification information from an IC card on which the ticket information and the buyer identification information are written and for sending the ticket information and the buyer identification information to said sales center unit,
wherein said sales center unit, upon receipt of the ticket information and the buyer identification information from said ticket gate terminal, compares the received ticket information and the buyer identification information with ticket information and buyer identification information stored in a database at said sales center unit when said sales center unit generated the ticket information, and sends the comparison result to said ticket gate terminal;
means for receiving the comparison result from said sales center unit; and
means for controlling an admission of a user such that the user is admitted if the comparison result is true and is rejected if the comparison result is false.

31. A computer program product causing a computer on a user terminal to execute processes of steps (a1)-(a5), said user terminal being connected to a ticket sales center unit over a network:
(a1) displaying ticket product information on a display unit of said user terminal, said ticket product information being sent from said sales center unit over the network;
(a2) sending purchase order information and credit card information to said sales center unit over the network, said purchase order information being entered from an input unit by a user (hereinafter called a buyer) who orders a ticket and being product information on the ticket to be purchased, said credit card information being entered from the input unit by the user and being used for transferring a charge;
(a3) receiving the buyer identification information and the ticket information from said sales center unit that received the purchase order information and the credit card information used for transferring the charge;
(a4) sending the buyer identification information and the ticket information to an IC card writer connected to said user terminal, to write the information on an IC card; and
(a5) displaying information when unavailability information is received from said sales center unit, said information indicating that the ordered ticket could not be purchased.

32. A computer program product causing a server computer on a sales center unit to execute processes of steps (b1)-(b4), said sales center unit being connected to a user terminal and a charge-transfer terminal over a network:
(b1) receiving, from said user terminal, purchase order information and credit card information used for transferring a charge;
(b2) generating credit instruction information based on the credit card information to send said credit instruction information to said charge-transfer terminal;
(b3) generating buyer identification information based on the purchase order information to send said buyer identification information, as well as information on a purchased ticket, to said user terminal unit if charge transferability information from said charge-transfer terminal indicates that the charge may be transferred, said buyer identification information indicating a buyer, order contents, and an order date/time; and
(b4) generating unavailability information to send the unavailability information to said user terminal if the charge transferability information sent from said charge-transfer terminal indicates that the charge cannot be transferred.

33. The computer program product as defined in claim 32, wherein the program further causes the server computer on said sales center unit to receive the ticket information and the buyer identification information sent from a ticket gate terminal connected to said sales center unit, installed at a predetermined place such as a gate or an admission entrance and having an IC card reader installed, compare the received ticket information and the buyer identification information with the ticket information and the buyer identification information stored in a database at said sales center unit, and send the comparison result to said ticket gate terminal.

34. A computer program product causing a computer on a charge-transfer terminal to transfer a charge and send charge transferability information to said sales center unit, based on the credit card instruction information sent from said sales center unit as defined by claim 32 or 33, said charge transferability information indicating whether the charge may be transferred.

35. A computer program product causing a computer on a ticket gate terminal to execute processes of steps (c1)-(c4), said ticket gate terminal being connected to a sales center unit, installed at a predetermined place such as a ticket gate or an admission entrance, and connected to an IC card reader:
(c1) reading, via the IC card reader, ticket information and buyer identification information from an IC card on which the ticket information and the buyer identification information are written, display the ticket information on a display unit of said ticket gate terminal;
(c2) sending the ticket information selected by a user from the ticket information displayed on the display unit, as well as the buyer identification information corresponding to the ticket information, to said sales center unit,
wherein said sales center unit, upon receipt of the ticket information and the buyer identification information from said ticket gate terminal, compares the received ticket information and the buyer identification information with ticket information and buyer identification information stored in a database at said sales center unit when the ticket information was generated, and sends the comparison result to said ticket gate terminal;
(c3) receiving a comparison result from said sales center unit; and
(c4) controlling an admission of a user such that the user is admitted if the comparison result is true and is rejected if the comparison result is false.
